(19) United States
(12) Patent Application Publication
(10) Pub. No.: US 2023/0054559 A1
(43) Pub. Date: Feb. 23, 2023

(54) UTILITY KNIFE

(71) Applicant: Hong Ann Tool Industries Co., Ltd., Taichung City (TW)

(72) Inventor: Cheng-Wei SU, Taichung City (TW)

(21) Appl. No.: 17/697,053

(22) Filed: Mar. 17, 2022

(30) Foreign Application Priority Data
Aug. 17, 2021 (TW) 110130323

(51) Int. Cl. B26B 5/00; B26B 1/08

(52) U.S. Cl. CPC B26B 5/001; B26B 1/08

(57) ABSTRACT

An utility knife includes a housing, a blade seat, a blade, and a switching assembly. The housing has a chamber, an opening formed at an end of the chamber, and a switch slot communicating with the chamber. The blade seat is arranged in the chamber and has a blade holding slot and a guiding slot communicating with the blade holding slot. The blade is detachably mounted to the blade holding slot and has at least one engaging slot. The switching assembly includes a toggle switch movably arranged to the switch slot and exposed to the housing, an engaging block disposed at an end of the toggle switch and movably arranged to the guiding slot, and a biasing member elastically biasing the engaging block relative to the guiding slot.

### BACKGROUND OF THE INVENTION

The present invention relates to an utility knife and, more particularly, to an utility knife with easy to replace a blade.

Taiwan Utility Patent No. M289687 discloses a blade retreating structure of a gravity utility knife, which includes a suppressing component and a control component that are both provided on a cutter seat, and a single cutter blade is provided in the cutter seat. The suppressing component has a lever assembly that is capable of tilting, and the control component can drive the lever assembly. The lever assembly can position the cutter blade by pressing. The lever assembly can be separated with the cutter blade by rotating the control component to shift the lever assembly, so that the cutter blade can be rapidly and conveniently separated from the cutter seat.

However, when a user wants to assemble a new cutter blade to the cutter seat, the user must keep pushing a key body with finger, so that one end of the lever assembly can be kept upward, so as to prevent the new cutter blade from being blocked by a positioning block of the lever assembly and unable to enter the cutter seat. Therefore, once the user wants to replace the new cutter blade, the finger must keep pushing against the key body, which is not conducive to the operation of replacing the new cutter blade.

Thus, a need exists for a novel utility knife that mitigates and/or obviates the above drawbacks.

### BRIEF SUMMARY OF THE INVENTION

An objective of the present invention is to provide an utility knife, which includes a housing, a blade seat, a blade, and a switching assembly. The housing has a chamber, an opening formed at an end of the chamber, and a switch slot communicating with the chamber. The blade seat is arranged in the chamber and has a blade holding slot and a guiding slot communicating with the blade holding slot. The blade is detachably mounted to the blade holding slot and has at least one engaging slot. The switching assembly includes a toggle switch movably arranged to the switch slot and exposed to the housing, an engaging block disposed at an end of the toggle switch and movably arranged to the guiding slot, and a biasing member elastically biasing the engaging block relative to the guiding slot. The toggle switch is configured to drive the engaging block to move relative to the guiding slot, so that the engaging block is detachably engaged with the at least one engaging slot of the blade.

In an example, the engaging block has an engaging portion detachably engaged with the at least one engaging slot, and an abutted portion constantly abutted by the biasing member. The engaging portion further forms an inclined surface detachably abutting against the blade.

In an example, an inner wall surface of the guiding slot is extended to form a stopping portion configured to selectively stop the engaging portion as the engaging block moves relative to the guiding slot.

In an example, the toggle switch has a toggle portion exposed to the housing and a driving portion extending from the toggle portion. The driving portion is configured to connect with the engaging portion to drive the engaging block to move relative to the guiding slot.

In an example, the biasing member is a spring plate and has a fixing end connected to the blade seat and an abutting end abutting against the abutted portion of the engaging block. The abutting end is configured to restorably pivot relative to the fixing end as the engaging block moves relative to the guiding slot.

In an example, the housing further has a button slot communicating with the chamber. The blade seat is movably arranged in the chamber. The utility knife further includes a slide button movably arranged to the button slot and connected to the blade seat to drive the blade seat to move relative to the chamber. The blade is selectively exposed to the opening as the blade seat moves relative to the chamber.

In an example, the blade seat has a proximal end adjacent to the opening and a distal end opposite to the proximal end. The blade holding slot extends from the proximal end to the distal end along a length direction. The guiding slot is disposed between the proximal end and the distal end and extends along a height direction perpendicular to the length direction to communicate with the blade holding slot. The fixing end of the biasing member is connected to the distal end.

In an example, the button slot is sequentially provided with at least two limiting portions along the length direction. The blade seat is provided with an extension portion extending along the length direction. The extension portion has a holding end fixed to the proximal end and a limiting end opposite to the holding end. The slide button is connected between the holding end and the limiting end and is adjacent to the limiting end. The slide button is configured to drive the limiting end to pivot relative to the holding end, so that the limiting end is configured to pivot relative to the holding end so as to detachably abut against one of the at least two limiting portions of the button slot.

In an example, the slide button is configured to detachably abut against the biasing member when the limiting end pivots relative to the holding end.

The present invention will become clearer in light of the following detailed description of illustrative embodiments of this invention described in connection with the drawings.

### DESCRIPTION OF THE DRAWINGS

FIG. 1 is a perspective view of an utility knife of an embodiment according to the present invention.

FIG. 2 is an exploded, perspective view of the utility knife of FIG. 1.

FIG. 3 is a cross sectional view of the utility knife of FIG. 1, and shows an engaging block engaged with an engaging slot of a blade.

FIGS. 4 and 5 are cross sectional views of the utility knife of FIG. 1, and show a toggle switch configured to drive the engaging block to move relative to a guiding slot so that the engaging block is detached from the engaging slot of the blade.

FIG. 6 is a cross sectional view of the utility knife of FIG. 1, and shows the engaging block detached from the engaging slot of the blade to move relative to a blade holding slot.

FIG. 7 is a continued view of FIG. 6, and shows a new blade entering the blade holding slot and abutting against the engaging block.

FIG. 8 is a cross sectional view of the utility knife of FIG. 1, and shows a slide button to drive a limiting end detached from a limiting portion of a button slot.

### DETAILED DESCRIPTION OF THE INVENTION

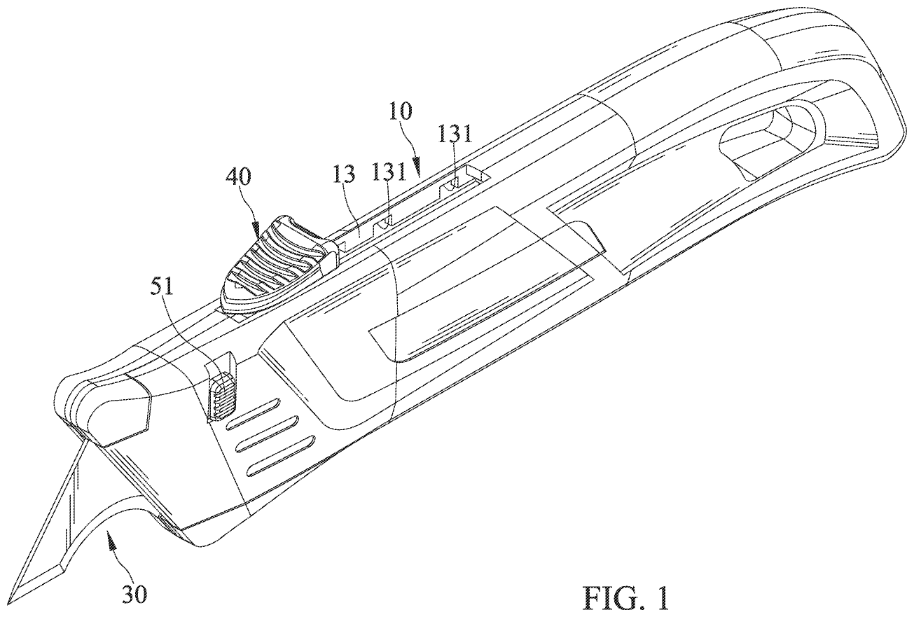

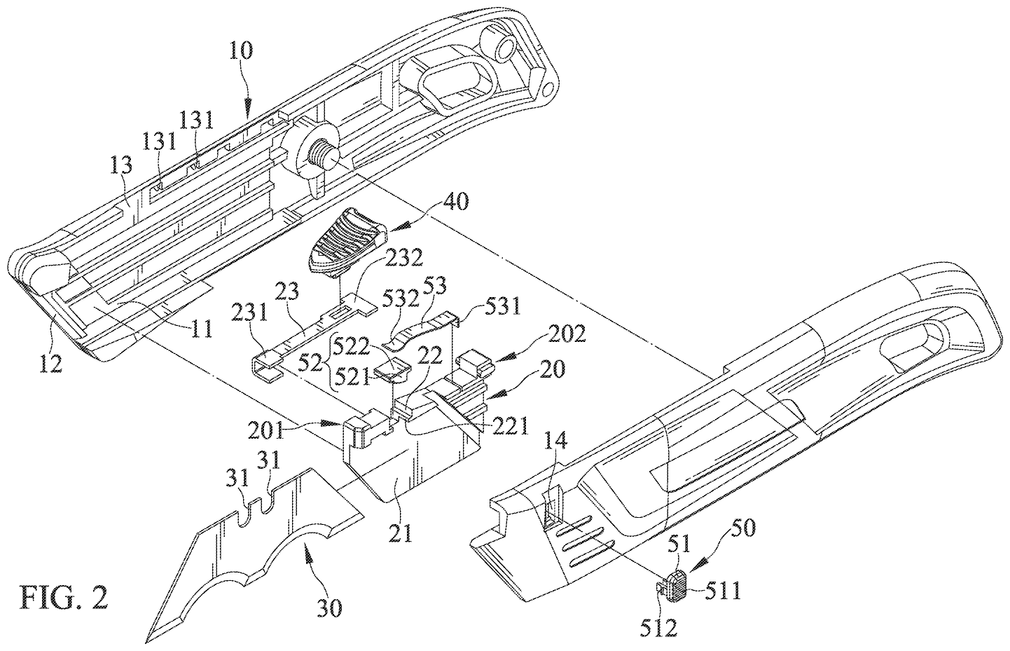

FIGS. 1-4 show an utility knife of an embodiment according to the present invention. The utility knife includes a housing 10, a blade seat 20, a blade 30, a slide button 40, and a switching assembly 50. The housing 10 has a chamber 11, an opening 12 formed at an end of the chamber 1U, a button slot 13 communicating with the chamber 11, and a switch slot 14 communicating with the chamber 11. The blade seat 20 is movably arranged in the chamber 11 and has a blade holding slot 21 and a guiding slot 22 communicating with the blade holding slot 21. The blade 30 is detachably mounted to the blade holding slot 21 to be selectively exposed to the opening 12 as the blade seat 20 moves relative to the chamber 11, and has at least one engaging slot 31. The blade 30 of the embodiment may have two U-shaped engaging slots 31. The slide button 40 is movably arranged to the button slot 13 and connected to the blade seat 20 to drive the blade seat 20 to move relative to the chamber 11. The switching assembly 50 includes a toggle switch 51 movably arranged to the switch slot 14 and exposed to the housing 10, an engaging block 52 disposed at an end of the toggle switch 51 and movably arranged to the guiding slot 22, and a biasing member 53 elastically biasing the engaging block 52 relative to the guiding slot 22. The toggle switch 51 is configured to drive the engaging block 52 to move relative to the guiding slot 22, so that the engaging block 52 is detachably engaged with the engaging slot 31 of the blade 30.

The engaging block 52 has an engaging portion 521 detachably engaged with the engaging slot 31, and an abutted portion 522 constantly abutted by the biasing member 53. The engaging portion 521 forms an inclined surface 523 detachably abutting against the blade 30. Thus, the inclined surface 523 is used to assist the blade 30 entering the blade holding slot 21 and is adapted for abutting against the engaging block 52 and moving relative to the engaging block 52. An inner wall surface of the guiding slot 22 is extended to form a stopping portion 221 configured to selectively stop the engaging portion 521 as the engaging block 52 moves relative to the guiding slot 22, preventing the engaging block 52 from falling into the blade holding slot 21. The toggle switch 51 has a toggle portion 511 exposed to the housing 10 and a driving portion 512 extending from the toggle portion 511. The driving portion 512 is configured to connect with the engaging portion 521 to drive the engaging block 52 to move relative to the guiding slot 22. Thus, a user can drive the engaging block 52 via the toggle portion 511.

In the embodiment, the biasing member 53 may be a spring plate and has a fixing end 531 connected to the blade seat 20 and an abutting end 532 abutting against the abutted portion 522 of the engaging block 52. The abutting end 532 is configured to restorably pivot relative to the fixing end 531 as the engaging block 52 moves relative to the guiding slot 22.

Further, the blade seat 20 has a proximal end 201 adjacent to the opening 12 and a distal end 202 opposite to the proximal end 201. The blade holding slot 21 extends from the proximal end 201 to the distal end 202 along a length direction. The guiding slot 22 is disposed between the proximal end 201 and the distal end 202 and extends along a height direction perpendicular to the length direction to communicate with the blade holding slot 21, so that the engaging portion 521 of the engaging block 52 can enter the blade holding slot 21 via the guiding slot 22. The fixing end 531 of the biasing member 53 is fixedly connected to the distal end 202 of the blade seat 20 in an embedded manner.

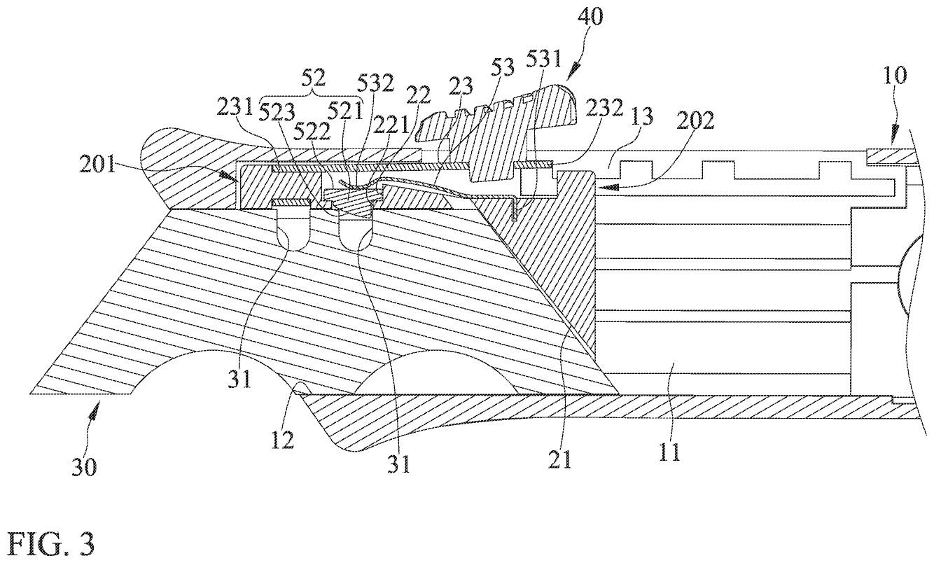

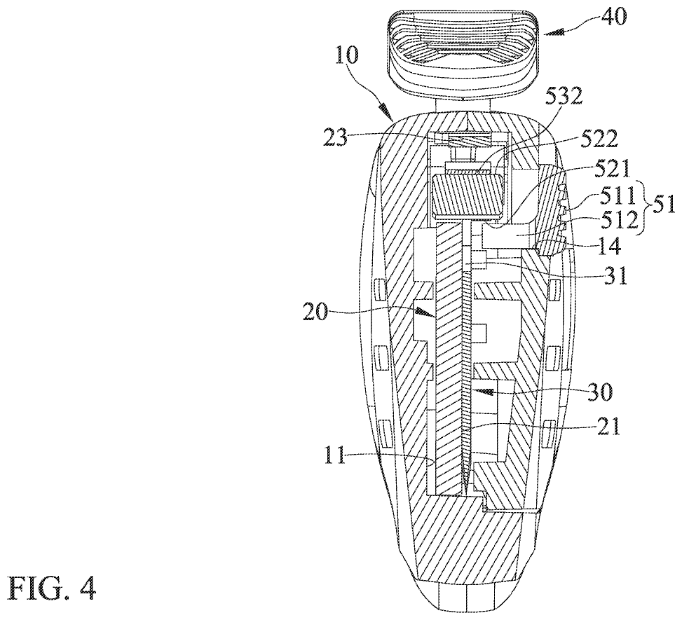

As shown in FIGS. 3 and 4, the engaging portion 521 of the engaging block 52 enters the blade holding slot 21 of the blade seat 20 and is engaged with the engaging slot 31 of the blade 30, so that the blade 30 cannot be detached from the blade holding slot 21 of the blade seat 20.

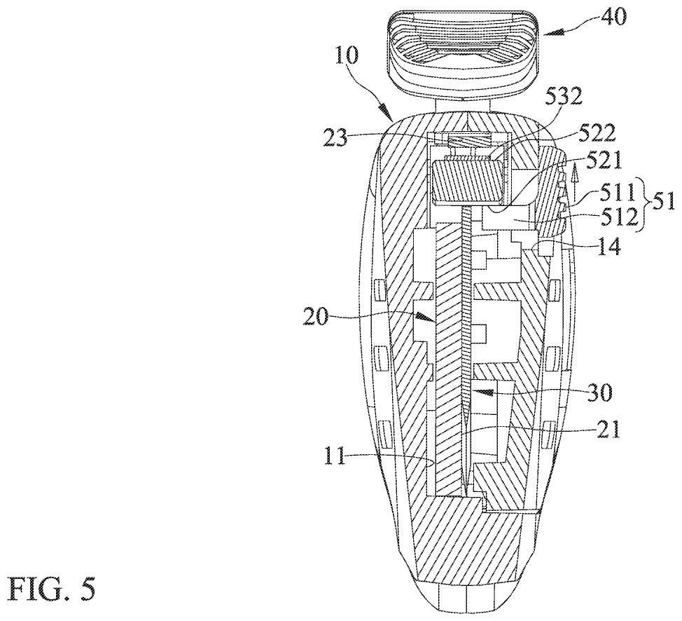

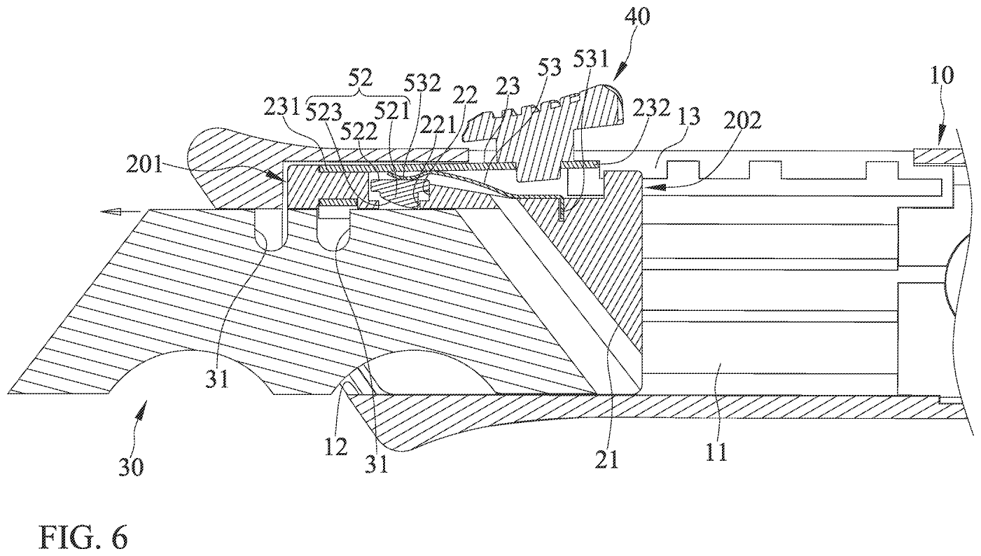

As shown in FIGS. 5 and 6, the user can toggle the toggle portion 511 of the toggle switch 51 so that the toggle switch 51 moves relative to the switch slot 14, and then the driving portion 512 drives the engaging block 52 to move relative to the guiding slot 22, so that the engaging portion 521 of the engaging block 52 is detached from the engaging slot 31 of the blade 30. As shown in FIG. 6, the user can pull the blade 30 away from the blade holding slot 21 along the length direction until the blade 30 is detached from the housing 10 via the opening 12 and stops contacting the toggle switch 51. During this operation, the engaging block 52 abuts against the blade 30, the abutting end 532 of the biasing member 53 is pushed by the engaging block 52 to pivot relative to the fixed end 531 elastically and restorably. Once the blade 30 is completely detached from the blade holding slot 21, the abutting end 532 of the biasing member 53 is subjected to elastic restoring force and pivots relative to the fixed end 531 again, so that the engaging portion 521 of the engaging block 52 enters the blade holding slot 21 of the blade seat 20.

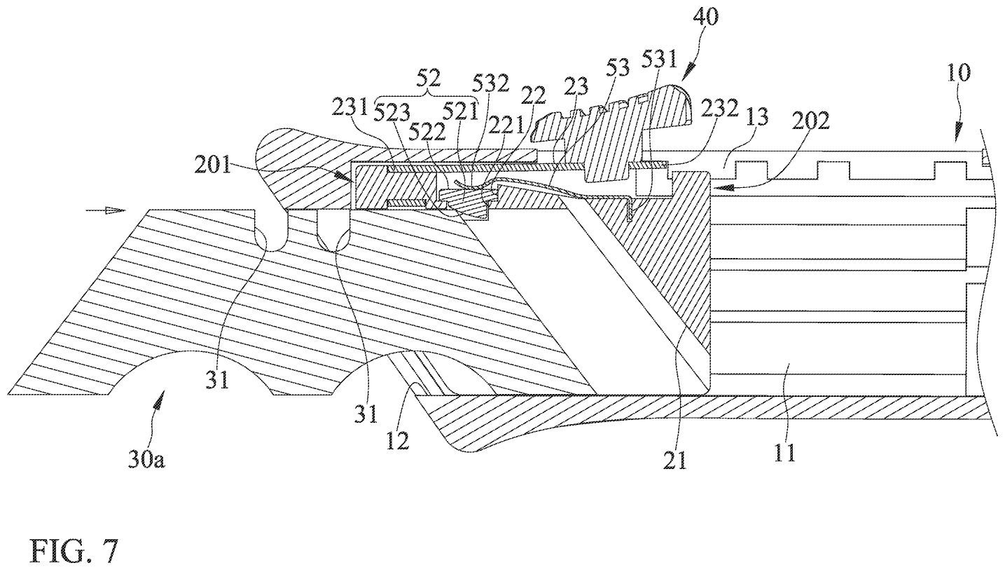

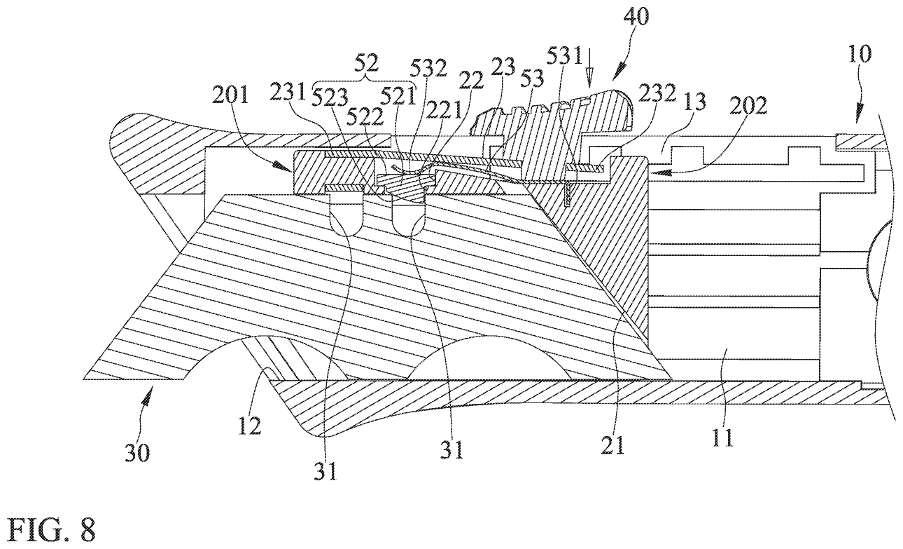

As shown in FIG. 7, the user can insert a new blade 30a to be replaced into the blade holding slot 21 via the opening 12. At this time, there is no need to operate the toggle switch 51, and the user only needs to push the new blade 30a to move relative to the blade holding slot 21 and abut against the engaging portion 521 of the engaging block 52, so that the engaging block 52 moves relative to the guiding slot 22. The user continues to push the new blade 30a until the engaging portion 521 of the engaging block 52 corresponds to an engaging slot 31 of the new blade 30a. At this time, the abutting end 532 of the biasing member 53 is pivoted relative to the fixing end 531 by the elastic restoring force and abuts against the abutted portion 522 of the engaging block 52, so as to drive the engaging portion 521 of the engaging block 52 to be engaged with the engaging slot 31 of the new blade 30a. The new blade 30a is installed without touching the toggle switch 51.

Furthermore, the button slot 13 is sequentially provided with at least two limiting portions 131 along the length direction. The blade seat 20 is provided with an extension portion 23 extending along the length direction. The extension portion 23 is flexible has a holding end 231 fixed to the proximal end 201 and a limiting end 232 opposite to the holding end 231. The limiting end 232 is configured to pivot relative to the holding end 231 so as to detachably abut against one of the at least two limiting portions 131 of the button slot 13, so that the blade seat 20 can selectively slide relative to the chamber 11.

The slide button 40 is connected between the holding end 231 and the limiting end 232 and is adjacent to the limiting end 232. The slide button 40 is configured to drive the limiting end 232 to pivot relative to the holding end 231, so that the limiting end 232 is configured to pivot relative to the holding end 231 so as to detachably abut against one of the at least two limiting portions 131 of the button slot 13. Further, the slide button 40 is configured to detachably abut against the biasing member 53 when the limiting end 232 pivots relative to the holding end 231. In addition, when the slide button 40 drives the limiting end 232 to pivot relative to the holding end 231, the slide button 40 can detachably abut against the biasing member 53.

Therefore, the user can press the slide button 40 to cause the limiting end 232 of the extension portion 23 pivoting relative to the holding end 231 and to be detached from the limiting portion 131 of the button slot 13, and at the same time slide the slide button 40 to drive the blade seat 20 to move relative to the chamber 11 to adjust a length of the blade 30 exposed to the opening 12. After adjusting to the desired length, the force on the slide button 40 can be stopped, and the limiting end 232 is pivoted relative to the holding end 231 by the elastic restoring force, so as to abut against the limiting portion 131 of the button slot 13 to prevent the blade seat 20 to slide relative to the chamber 11.

Although specific embodiments have been illustrated and described, numerous modifications and variations are still possible without departing from the scope of the invention. The scope of the invention is limited by the accompanying claims.

1. An utility knife comprising:
a housing having a chamber, an opening formed at an end of the chamber, and a switch slot communicating with the chamber;
a blade seat arranged in the chamber and having a blade holding slot and a guiding slot communicating with the blade holding slot;
a blade detachably mounted to the blade holding slot and having at least one engaging slot; and
a switching assembly including a toggle switch movably arranged to the switch slot and exposed to the housing, an engaging block disposed at an end of the toggle switch and movably arranged to the guiding slot, and a biasing member elastically biasing the engaging block relative to the guiding slot, and wherein the toggle switch is configured to drive the engaging block to move relative to the guiding slot, so that the engaging block is detachably engaged with the at least one engaging slot of the blade.

2. The utility knife as claimed in claim 1, wherein the engaging block has an engaging portion detachably engaged with the at least one engaging slot, and an abutted portion constantly abutted by the biasing member, and wherein the engaging portion forms an inclined surface detachably abutting against the blade.

3. The utility knife as claimed in claim 2, wherein an inner wall surface of the guiding slot is extended to form a stopping portion configured to selectively stop the engaging portion as the engaging block moves relative to the guiding slot.

4. The utility knife as claimed in claim 2, wherein the toggle switch has a toggle portion exposed to the housing and a driving portion extending from the toggle portion, and wherein the driving portion is configured to connect with the engaging portion to drive the engaging block to move relative to the guiding slot.

5. The utility knife as claimed in claim 2, wherein the biasing member is a spring plate and has a fixing end connected to the blade seat and an abutting end abutting against the abutted portion of the engaging block, and wherein the abutting end is configured to restorably pivot relative to the fixing end as the engaging block moves relative to the guiding slot.

6. The utility knife as claimed in claim 5, wherein the housing further has a button slot communicating with the chamber, wherein the blade seat is movably arranged in the chamber, wherein the utility knife further comprises:
a slide button movably arranged to the button slot and connected to the blade seat to drive the blade seat to move relative to the chamber, and wherein the blade is selectively exposed to the opening as the blade seat moves relative to the chamber.

7. The utility knife as claimed in claim 6, wherein the blade seat has a proximal end adjacent to the opening and a distal end opposite to the proximal end, wherein the blade holding slot extends from the proximal end to the distal end along a length direction, wherein the guiding slot is disposed between the proximal end and the distal end and extends along a height direction perpendicular to the length direction to communicate with the blade holding slot, and wherein the fixing end of the biasing member is connected to the distal end.

8. The utility knife as claimed in claim 7, wherein the button slot is sequentially provided with at least two limiting portions along the length direction, wherein the blade seat is provided with an extension portion extending along the length direction, wherein the extension portion has a holding end fixed to the proximal end and a limiting end opposite to the holding end, wherein the slide button is connected between the holding end and the limiting end and is adjacent to the limiting end, wherein the slide button is configured to drive the limiting end to pivot relative to the holding end, so that the limiting end is configured to pivot relative to the holding end so as to detachably abut against one of the at least two limiting portions of the button slot.

9. The utility knife as claimed in claim 7, wherein the slide button is configured to detachably abut against the biasing member when the limiting end pivots relative to the holding end.
